(19) United States
(12) Patent Application Publication
(10) Pub. No.: US 2011/0134215 A1
(43) Pub. Date: Jun. 9, 2011

(54) METHOD AND APPARATUS FOR PROVIDING 3D IMAGE AND METHOD AND APPARATUS FOR DISPLAYING 3D IMAGE

(75) Inventor: Ji-won KIM, Seoul (KR)

(73) Assignee: SAMSUNG ELECTRONICS CO., LTD., Suwon-si (KR)

(21) Appl. No.: 12/939,549

(22) Filed: Nov. 4, 2010

(30) Foreign Application Priority Data
Dec. 4, 2009 (KR) 10-2009-0119899

(51) Int. Cl. H04N 13/04; H04N 13/00

(52) U.S. Cl. 348/43; 348/51; 348/E13.06; 348/E13.026

(57) ABSTRACT

Provided are a method and apparatus for providing a 3D image and a method and apparatus for displaying a 3D image. The method for providing a 3D image includes: inserting an identification mark into 3D image data, the 3D image including a left-eye image and a right-eye image, for distinguishing the left-eye image and the right-eye image; and transmitting the identification mark-inserted 3D image data to a display apparatus

### CROSS-REFERENCE TO RELATED APPLICATION

This application claims priority from Korean Patent Application No. 10-2009-0119899, filed on Dec. 4, 2009 in the Korean Intellectual Property Office, the disclosure of which is incorporated herein by reference in its entirety.

### BACKGROUND

1. Field

Apparatuses and methods consistent with the exemplary embodiments relate to providing and displaying a three-dimensional (3D) image, and more particularly, realizing a 3D image by displaying a left-eye image and a right-eye image on a screen alternately.

2. Description of the Related Art

Three-dimensional (3D) stereoscopy has applications in diverse fields such as information communication, broadcasting, medical service, education and training, military, games, animation, virtual reality, CAD, and industrial technologies. Also, three-dimensional (3D) stereoscopy is the core base technology of next generation 3D stereoscopic multimedia information communication, which is commonly required in the aforementioned diverse fields.

The stereoscopic sense that a person perceives is generally generated by the complex action of diverse factors, such as a degree of change in thickness of eye lens according to the location of an object to be observed, an angle difference between each eye and the object being viewed, a difference in location and shape of the object observed from the right and left eyes, a time difference generated by movement of the object, and other diverse psychological and memory effects.

Among them, binocular disparity, which appears due to the horizontal separation of about 6-7 cm between the two eyes of a person, is the most important factor in the stereoscopic sense. That is, a person observes an object with an angle difference due to the binocular disparity and thus images entering the two eyes have different images. If these two images are transmitted to the brain through the retinas, the brain accurately combines two pieces of information and thus perceives an original 3D stereoscopic image.

Three-dimensional image display apparatuses are divided into two categories: a glass type using special glasses and a non-glass type which does not use special glasses. The glass type employs a color filter scheme which separates and selects an image using complementary color filters, a polarization filter scheme which separates a left-eye image and a right-eye image using a light shielding effect obtained by combination of orthogonal polarization elements, and a shutter glass scheme which alternately shades the left-eye and the right-eye in response to a synchronization signal which projects a left-eye image signal and a right-eye image signal onto a screen, thereby allowing the person to perceive the stereoscopic sense.

The 3D image consists of a left-eye image, which is perceived by the left-eye, and a right eye image, which is perceived by the right-eye. The 3D image display apparatus presents the stereoscopic sense of the image using the time difference between the left-eye image and the right-eye image.

In a 3D display apparatus, it may be difficult to distinguish the left-eye image and the right-eye image of the 3D image since their shapes are similar to each other. Also, if the left-eye image and the right-eye image are displayed out of position, the 3D image is not normally displayed.

Accordingly, the 3D display apparatus is required to distinguish the left-eye image and the right accurately. Therefore, there is a need for a method for distinguish a left-eye image and a right-eye image by a 3D display apparatus.

### SUMMARY

Exemplary embodiments overcome the above disadvantages and other disadvantages not described above. However, it is understood that an exemplary embodiment is not required to overcome the disadvantages described above, and an exemplary embodiment may not overcome any of the problems described above.

Exemplary embodiments provide a method and apparatus for providing a 3D image and a method and apparatus for displaying a 3D image. More particularly, the exemplary embodiments insert an identification mark for distinguishing a left-eye image and a right-eye image into 3D image data including the left-eye image and the right-eye image, and transmit the identification mark-inserted 3D image data to a display apparatus.

According to an aspect of an exemplary embodiment, there is provided a method for providing a 3D image, the method including: inserting an identification mark into 3D image data, the 3D image data comprising a left-eye image and a right-eye image, for distinguishing the left-eye image and the right-eye image, and transmitting the identification mark-inserted 3D image data to a display apparatus.

The 3D image data may be 3D image data of a frame sequential scheme wherein a frame corresponding to the left-eye image and a frame corresponding to the right-eye image are transmitted in sequence.

The 3D image data may be 3D image data of a field sequential scheme wherein a field corresponding to the left-eye image and a field corresponding to the right-eye image are transmitted in sequence.

The inserting may insert the identification mark into one of a header area of the left-eye image or a header area of the right-eye image.

The transmitting may transmit the identification mark-inserted 3D image data to the display apparatus through a high-definition multimedia interface (HDMI), and the inserting may insert the identification mark into one of a control period or a data island period of a stream area of an HDMI format.

The inserting may insert the identification mark into a sync signal.

The inserting may insert the identification mark into the sync signal by changing a polarity of a Vsync within a Vblanking period of the sync signal.

According to an aspect of another exemplary embodiment, there is provided a 3D image providing apparatus including: a controller which controls an identification mark to be inserted into 3D image data, the 3D image data comprising a left-eye image and a right-eye image, for distinguishing the left-eye image and the right-eye image, and an interface which transmits the identification mark-inserted 3D image data to a display apparatus.

The 3D image data may be 3D image data of a frame sequential scheme wherein a frame corresponding to the left-eye image and a frame corresponding to the right-eye image are transmitted in sequence.

The 3D image data may be 3D image data of a field sequential scheme wherein a field corresponding to the left-eye image and a field corresponding to the right-eye image are transmitted in sequence.

The controller may insert the identification mark into one of a header area of the left-eye image or a header area of the right-eye image.

The interface may transmit the identification mark-inserted 3D image data to the display apparatus through an HDMI, and the controller may insert the identification mark into one of a control period or a data island period of a stream area of an HDMI format.

The controller may insert the identification mark into a sync signal.

The controller may insert the identification mark into the sync signal by changing a polarity of a Vsync within a Vblanking period of the sync signal.

According to an aspect of still another exemplary embodiment, there is provided a method for displaying a 3D image, the method including: receiving 3D image data comprising an identification mark for distinguishing a left-eye image and a right-eye image, distinguishing the left-eye image and the right-eye image of the received 3D image data based on the identification mark, generating a left-eye image frame corresponding to the left-eye image of the 3D image data and a right-eye image frame corresponding to the right-eye image of the 3D image data, and producing a 3D image, and displaying the left-eye image frame and the right-eye image frame alternately.

The 3D image data may further be 3D image data of a frame sequential scheme wherein a frame corresponding to the left-eye image and a frame corresponding to the right-eye image are transmitted in sequence.

The 3D image data may be 3D image data of a field sequential scheme wherein a field corresponding to the left-eye image and a field corresponding to the right-eye image are transmitted in sequence.

The distinguishing may distinguish the left-eye image and the right-eye image of the received 3D image data based on the identification mark which is inserted into one of a header area of the left-eye image or a header area of the right-eye image.

The receiving may receive the identification mark-inserted 3D image data through an HDMI, and the distinguishing may distinguish the left-eye image and the right-eye image of the received 3D image data based on the identification mark which is inserted into one of a control period or a data island period of a stream area of an HDMI format.

The distinguishing may distinguish the left-eye image and the right-eye image of the received 3D image data based on the identification mark which is inserted into a sync signal.

The distinguishing may distinguish the left-eye image and the right-eye image of the received 3D image data based on the identification mark which corresponds to a polarity of a Vsync within a Vblanking period of the sync signal.

According to an aspect of yet another exemplary embodiment, there is provided a 3D image display apparatus including: an image receiver which receives 3D image data, the 3d image data comprising an identification mark for distinguishing a left-eye image and a right-eye image; a controller which distinguishes the left-eye image and the right-eye image of the received 3D image data based on the identification mark, and a 3D realization unit which generates a left-eye image frame corresponding to the left-eye image of the 3D image data and a right-eye image frame corresponding to the right-eye image of the 3D image data.

The 3D image data may be 3D image data of a frame sequential scheme wherein a frame corresponding to the left-eye image and a frame corresponding to the right-eye image are transmitted in sequence.

The 3D image data may be 3D image data of a field sequential scheme wherein a field corresponding to the left-eye image and a field corresponding to the right-eye image are transmitted in sequence.

The controller may distinguish the left-eye image and the right-eye image of the received 3D image data based on the identification mark which is inserted into one of a header area of the left-eye image or a header area of the right-eye image.

The image receiver receives the identification mark-inserted 3D image data through an HDMI, and the controller distinguishes the left-eye image and the right-eye image of the received 3D image data based on the identification mark which is inserted into one of a control period or a data island period of a stream area of an HDMI format.

The controller may distinguish the left-eye image and the right eye image of the 3D image data based on the identification mark which is inserted into a sync signal.

The controller may distinguish the left-eye image and the right-eye image of the received 3D image data based on the identification mark which corresponds to a polarity of a Vsync period within a Vblanking period of the sync signal.

The 3D image display apparatus may further include a display unit which displays the left-eye image frame and the right-eye image frame alternately.

Additional aspects and advantages of the present inventive concept will be set forth in the detailed description, will be obvious from the detailed description, or may be learned by practicing the invention.

### BRIEF DESCRIPTION OF THE DRAWINGS

The above and/or other aspects will be more apparent by describing in detail exemplary embodiments, with reference to the accompanying drawings in which:

FIG. 1 is a view illustrating a digital versatile disk (DVD) player for providing a three-dimensional (3D) image and a 3D TV for displaying a 3D image according to an exemplary embodiment;

FIG. 2 is a block diagram illustrating a DVD player according to an exemplary embodiment;

FIG. 3 is a block diagram illustrating a 3D TV capable of displaying a 3D image according to an exemplary embodiment;

FIG. 4 is a flowchart illustrating a method for providing a 3D image and a method for displaying a 3D image according to an exemplary embodiment;

FIG. 5A is a view illustrating a 3D image of a frame sequential scheme according to an exemplary embodiment;

FIG. 5B is a view illustrating a 3D image of a field sequential scheme according to an exemplary embodiment;

FIG. 6 is a view illustrating a structure of a stream area of a high definition multimedia interface (HDMI) format according to an exemplary embodiment;

FIG. 7 is a view illustrating an identification mark which is inserted using a polarity of a Vsync within a Vblanking according to an exemplary embodiment; and

FIG. 8 is a view illustrating Vactive and Vblank information according to an exemplary embodiment.

### DETAILED DESCRIPTION OF THE EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the invention with unnecessary detail.

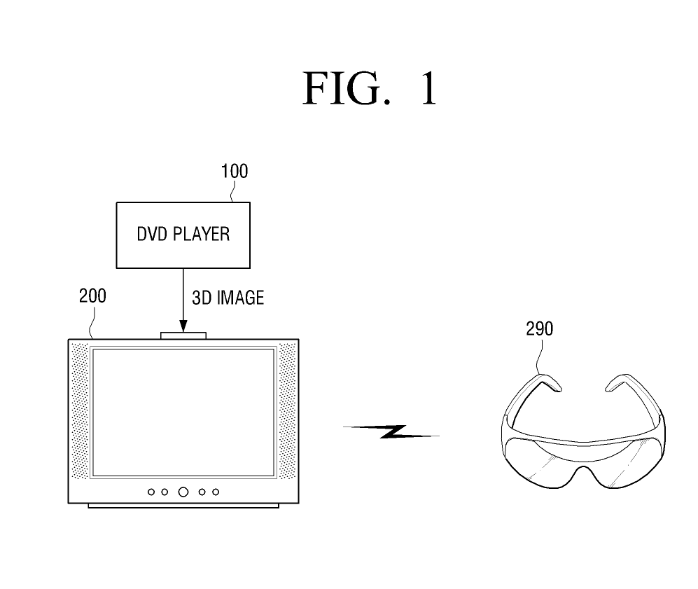

FIG. 1 is a view illustrating a digital versatile disk (DVD) player for providing a three-dimensional (3D) image and a 3D TV 200 for displaying a 3D image according to an exemplary embodiment. The 3D TV 200 is communicable with a pair of glasses 290.

The DVD player 100 reads out 3D image data from a DVD and transmits the 3D image data to the 3D TV 200. The DVD player 100 inserts an identification mark for distinguishing a left-eye image and a right-eye image into the 3D image data, and transmits the identification mark-inserted 3D image data to the 3D TV 200.

The identification mark, recited herein, refers to an identifier indicating whether the frame or field included in the 3D image data is about the left-eye image or the right-eye image. The identification mark may be inserted into a header area of the left-eye image or a header area of the right-eye image or may be inserted into a sync signal.

The 3D image data may include the left-eye image and the right-eye image in various ways. More specifically, a frame sequential scheme may be applied to the 3D image data such that a frame corresponding to the left-eye image and a frame corresponding to the right-eye image are transmitted in sequence, or a field sequential scheme may be applied such that a field corresponding to the left-eye image and a field corresponding to the right-eye image are transmitted in sequence.

The 3D TV 200 receives the 3D image data including the identification mark for distinguishing the left-eye image and the right-eye image, and distinguishes the left-eye image and the right-eye image of the 3D image data based on the identification mark. The 3D TV 200 generates a left-eye image frame and a right-eye image frame corresponding to the 3D image data with reference to the identification mark. Then, the 3D TV 200 displays the left-eye image frame and the right-eye image frame alternately, thereby providing a 3D image.

As described above, the 3D TV 200 generates the left-eye image and the right-eye image and displays them alternately, and a user alternately sees the left-eye image and the right-eye image displayed on the 3D TV 200 with the user's left-eye and right-eye using the pair of glasses 290, so that the user can watch the 3D stereoscopic image.

More specifically, the 3D TV 200 generates the left-eye image frame and the right-eye image frame and alternately displays the generated left-eye image frame and the generated right-eye image frame on a screen at predetermined time intervals. The 3D TV 200 generates a sync signal regarding the left-eye image frame and the right-eye image frame and transmits the sync signal to the pair of glasses 290.

The pair of glasses 290 receives the sync signal transmitted from the 3D TV 200, and opens the left-eye glass and the right-eye glass alternately in synchronization with the left-eye image frame and the right-eye image frame being displayed on the 3D TV 200.

As described above, the user can watch the 3D image using the 3D TV 200 and the pair of glasses 290 of FIG. 1. Also, since the DVD player 100 provides the 3D image with the identification mark for distinguishing the left-eye image and the right-eye image, the 3D TV 200 can clearly distinguish the left-eye image and the right-eye image using the identification mark.

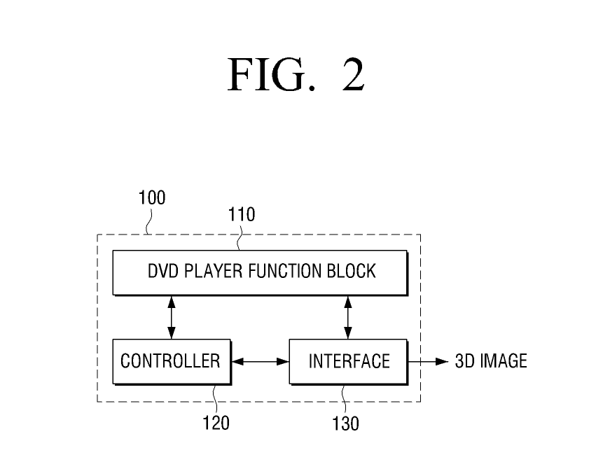

FIG. 2 is a block diagram illustrating a DVD player according to an exemplary embodiment. As shown in FIG. 2, the DVD player 100 includes a DVD player function block 110, a controller 120, and an interface 130.

The DVD player function block 110 performs the original function of the DVD player 100. More specifically, the DVD player function block 110 reads out image data from a loaded DVD. If a 3D image is recorded on the DVD, the DVD player function block 110 reads out 3D image data from the DVD.

The controller 120 controls the overall operation of the DVD player 100. More specifically, the controller 120 controls the insertion of an identification mark for distinguishing the left-eye image and the right-eye image to be inserted into the 3D image data. The controller 120 may insert the identification mark into the header area of the left-eye image or the header area of the right-eye image, or may insert the identification mark into a sync signal.

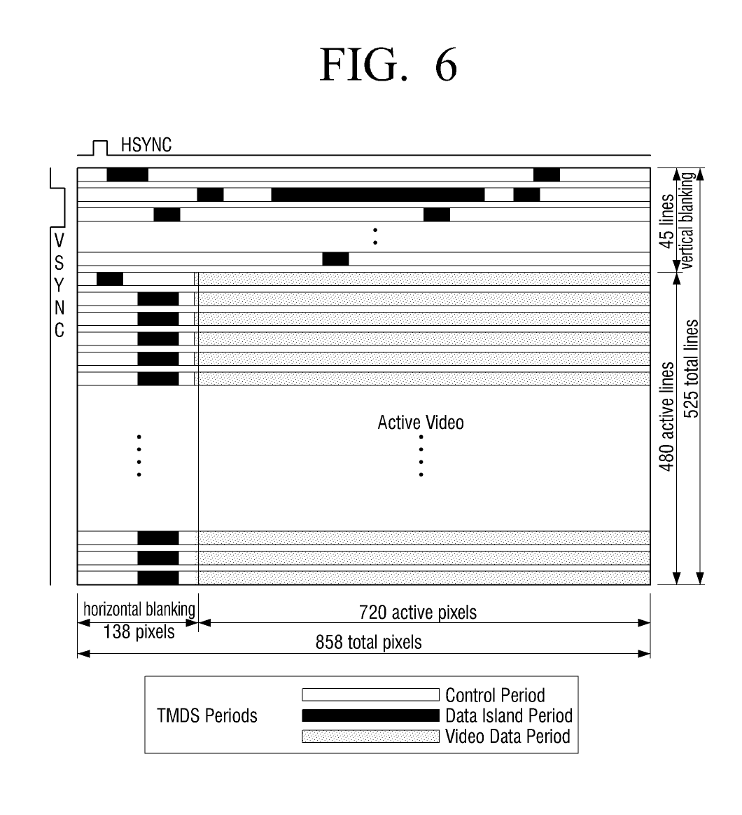

More specifically, the controller 120 may insert the identification mark into the header area of the stream of the left-eye image or the header area of the stream of the right-eye image, if the high-definition multimedia interface (HDMI) standard is applied. For example, a stream structure of one frame according to an HDMI format is illustrated in FIG. 6 and will be explained in detail below with reference to FIG. 6. The controller 120 may insert the identification mark into a control period or a data island period of the stream area of the HDMI format. In this case, the controller 120 may the identification mark into the control period or the data island period in the form of a tag.

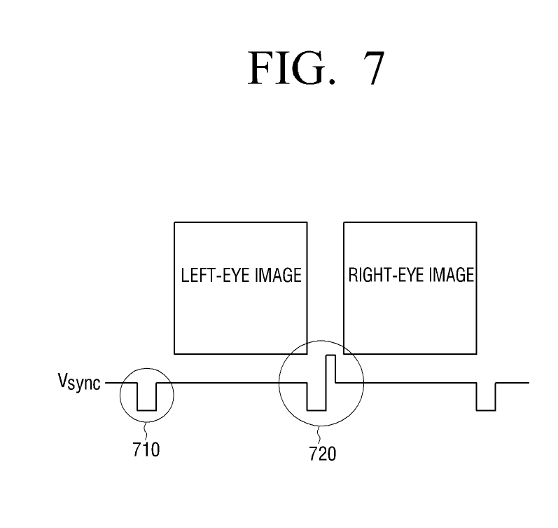

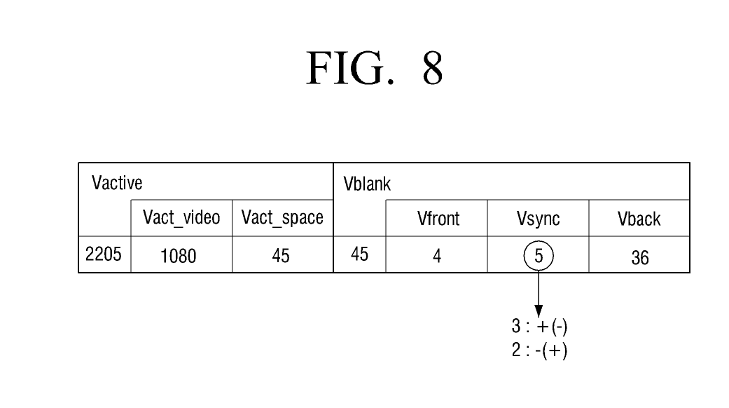

The controller 120 may insert the identification mark into a sync signal. For example, a vertical sync signal includes an active period (Vactive) and a blanking period (Vblank). The blanking period (Vblank) includes periods Vfront, Vsync, and Vback. A detailed structure of the sync signal will be explained below with reference to FIG. 8. The controller 120 may insert the identification mark into the sync signal by changing the polarity of the Vsync. The Vsync of which the polarity has been changed is illustrated in FIG. 7 and will be explained in detail below. Accordingly, the controller 120 may make the left-eye image and the right-eye image distinguished by changing the polarity of the Vsync of the right-eye image but not changing the polarity of the Vsync of the left-eye image. Conversely, the controller 120 may make the left-eye image and the right-eye image distinguished by changing the polarity of the Vsync of the left-eye image but not changing the polarity of the Vsync of the right-eye image.

The interface 130 transmits the identification mark-inserted 3D image data to the 3D TV 200. More specifically, the interface 130 may transmit the identification mark-inserted 3D image data to the 3D TV 200 through the HDMI. That is, the interface 130 may be the HDMI.

As described above, the DVD player 100 inserts the identification mark into the 3D image data and provides the identification mark-inserted 3D image data to the outside.

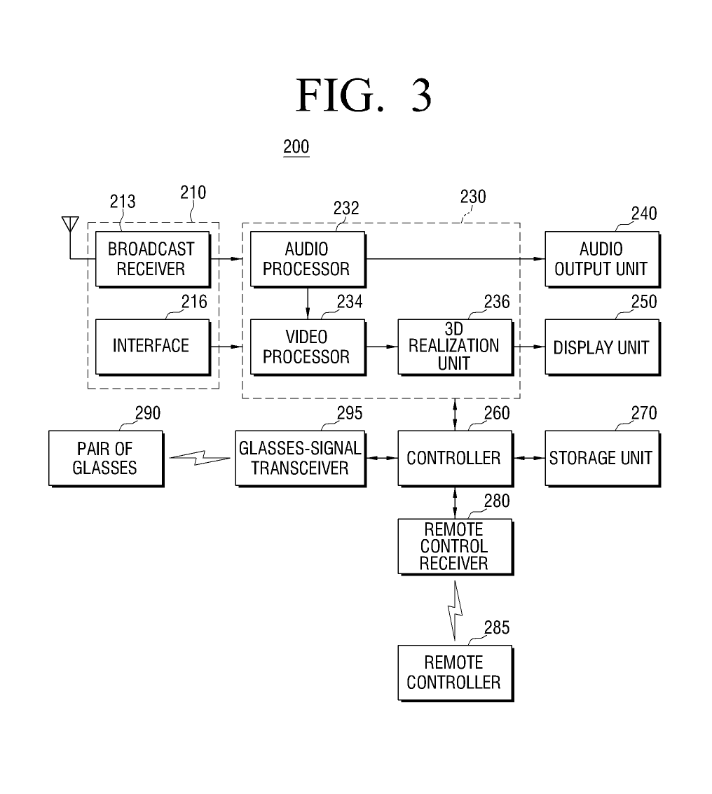

FIG. 3 is a block diagram illustrating a 3D TV 200 which displays a 3D image according to an exemplary embodiment. As shown in FIG. 3, the 3D TV 200 includes an image receiver 210, an audio/video processor 230, an audio output unit 240, a display unit 250, a controller 260, a storage unit 270, a remote control receiver 280, and a glasses-signal transceiver 295.

The image receiver 210 receives an image signal or image data from an external source. Also, the image receiver 210 receives 3D image data from an external source. As shown in FIG. 3, the image receiver 210 includes a broadcast receiver 213 and an interface 216.

The broadcast receiver 213 receives a broadcast from a broadcasting station or a satellite in a wired or wireless manner, and demodulates the broadcast. Also, the broadcast receiver 123 receives a 3D image signal including 3D image data.

The interface 216 is connected to an external apparatus such as a DVD player 100 to receive an image. In particular, the interface 216 may receive 3D image data from an external apparatus. The interface 216 interfaces in the format of S-Video, component, composite, D-Sub, DVI, HDMI.

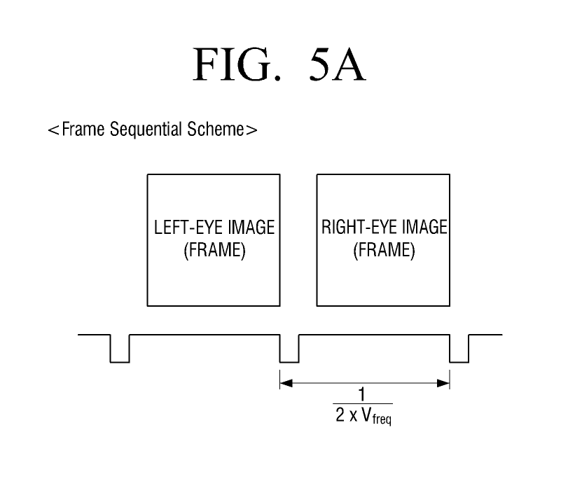

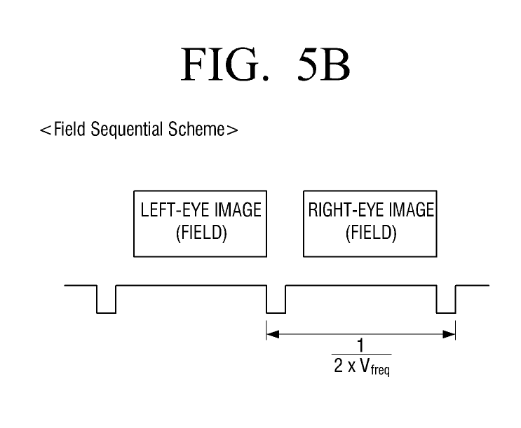

The 3D image data, recited herein, refers to data including 3D image information. The 3D image data includes left-eye image data and right-eye image data. The 3D image data is categorized according to how it includes the left-eye image data and the right-eye image data. More specifically, a frame sequential scheme may be applied to the 3D image data such that a frame corresponding to the left-eye image and a frame corresponding to the right-eye image are transmitted in sequence, or a field sequential scheme may be applied to the 3D image data such that a field corresponding to the left-eye image and a field corresponding to the right-eye image are transmitted in sequence. The types of 3D image data will be explained in detail below with reference to FIGS. 5A and 5B.

The image receiver 210 receives 3D image data including an identification mark for distinguishing the left-eye image and the right-eye image. More specifically, the interface 216 of the image receiver 210 may receive the identification mark-inserted 3D image data from the DVD player 100 through the HDMI.

The A/V processor 230 performs signal-processing such as video decoding, video scaling, and audio decoding with respect to the image signal and an audio signal input from the image receiver 210, and generates and inserts an on screen display (OSD).

On the other hand, if the input image and audio signals are to be stored in the storage unit 270, the A/V processor 230 compresses the input image and the input audio to store them in a compressed state.

As shown in FIG. 3, the A/V processor 230 includes an audio processor 232, a video processor 234, and a 3D realization unit 236.

The audio processor 232 performs signal-processing such as audio decoding with respect to the input audio signal. Also, the audio processor 232 outputs the processed audio signal to the audio output unit 240.

The video processor 234 performs signal-processing such as video decoding and video scaling with respect to the input image signal. Also, the video processor 234 processes the 3D image data and outputs the processed 3D image data to the 3D realization unit 236.

The 3D realization unit 236 generates a left-eye image frame and a right-eye image frame which are interpolated to the size of one frame using the input 3D image data. That is, the 3D realization unit 236 generates the left-eye image frame and the right-eye image frame to be displayed on the screen, for realizing a 3D stereoscopic image.

In the case of 3D image data of a field sequential scheme, one field data includes image data corresponding to a half size of one frame. In this case, the 3D image realization unit 236 enlarges or interpolates the distinguished left-eye image field and right-eye image field two times, thereby generating a left-eye image frame and a right-eye image frame to be displayed on the screen of one frame size. However, in the case of 3D image data of a frame sequential scheme, this operation is not required.

Also, the 3D realization unit 236 distinguishes the left-eye image data and the right-eye image data using the identification mark which is included in the input 3D image data. Since the 3D realization unit 236 can clearly distinguish the left-eye image data and the right-eye image data using the identification mark, the left-eye image frame is output at the time that the left-eye image should be output and the right-eye image frame is output at the time that the right-eye image should be output.

The 3D realization unit 236 outputs the generated left-eye image frame and the generated right-eye image frame to the display unit 250.

The audio output unit 240 outputs the audio transmitted from the A/V processor 230 to a speaker.

The display unit 250 displays the image transmitted from the A/V processor 230 on the screen. If the image is a 3D image, the display unit 250 displays the left-eye image frame and the right-eye image frame on the screen alternately.

The storage unit 270 stores programs necessary for the operation of the 3D TV 200 and stores a recorded image file. The storage unit 270 may be implemented as a hard disk or a non-volatile memory.

The remote control receiver 280 receives a user's manipulation from the remote controller 285 and transmits the user's manipulation to the controller 260.

The glasses-signal transceiver 295 transmits a clock signal to open the left-eye glass and the right-eye glass of the pair of glasses 290 alternately. Also, the pair of glasses 290 opens the left-eye glass and the right-eye glass alternately according to the received clock signal. Also, the glasses-signal transceiver 295 receives state information from the pair of glasses 290.

The controller 260 understands a user command based on the user's manipulation transmitted from the remote controller 290, and controls the overall operation of the 3D TV 200 according to the user command.

Also, the controller 260 controls the 3D TV 200 to operate in a 3D image display mode if 3D image data is input. Herein, the 3D image display mode refers to a mode which is activated if 3D image is input. If the 3D TV 200 is set to the 3D image display mode, the 3D realization unit 236 is activated.

The controller 260 may distinguish the left-eye image and the right-eye image of the received 3D image data based on the identification mark which is inserted into the header area of the left-eye image or the header area of the right-eye image, or may distinguish the left-eye image and the right-eye image of the received 3D image data based on the identification mark which is inserted into the sync signal.

More specifically, the controller 260 may distinguish the left-eye image and the right-eye image of the received 3D image data based on the identification mark inserted into the header area of the left-eye image or the header area of the right-eye image, if the HDMI standard is applied. For example, the stream structure of one frame according to the HDMI format is illustrated in FIG. 6 and will be explained in detail below. The controller 260 may distinguish the left-eye image and the right-eye image based on the identification mark which is inserted into the control period or the data island period of the stream area of the HDMI format. In this case, the controller 260 reads out the identification mark inserted into the control period or the data island period in the form of a tag, and identifies whether the current data is about the left-eye image or the right-eye image.

The controller 260 may distinguish the left-eye image and the right-eye image of the received 3D image data based on the identification mark which is inserted into the sync signal. For example, a vertical sync signal includes an active period (Vactive) and a blanking period (Vblank). The blanking period (Vblank) includes periods Vfront, Vsync, and Vback. The detailed configuration of the sync signal will be explained below with reference to FIG. 8. The controller 260 recognizes the identification mark inserted into the sync signal by detecting whether the polarity of the Vsync has been changed or not, and distinguishes the left-eye image and the right-eye image based on the identification mark. The Vsync of which the polarity has been changed is illustrated in FIG. 7 and will be explained in detail below. Accordingly, the controller 260 recognizes the left-eye image data if the polarity of the Vsync has not been changed and recognizes the right-eye image data if the polarity of the Vsync has been changed, thereby distinguishing the left-eye image and the right-eye image. Conversely, the controller 260 may recognize the right-eye image data if the polarity of the Vsync has not been changed and recognize the left-eye image data if the polarity of the Vsync has been changed, thereby distinguishing the left-eye image and the right-eye image.

As described above, the 3D TV 200 distinguishes the left-eye image and the right-eye image using the identification mark which is included in the 3D image data, and displays the left-eye image and the right-eye image alternately, thereby displaying a 3D image.

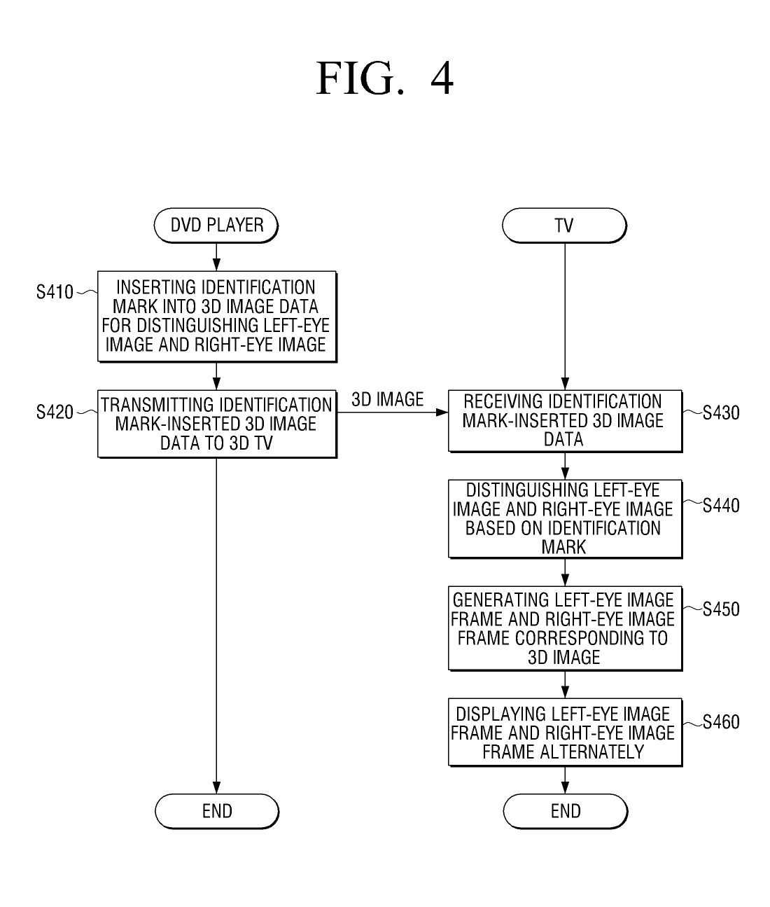

Hereinafter, a method for providing a 3D image and a method for displaying a 3D image will be explained in detail with reference to FIG. 4. FIG. 4 is a flowchart illustrating a method for providing a 3D image and a method for displaying a 3D image according to an exemplary embodiment.

The DVD player 100 inserts an identification mark into 3D image data so as to make a left-eye image and a right-eye image distinguished (S410). In this operation, the DVD player 100 may insert the identification mark into a header area of the left-eye image or a header area of the right-eye image, or may insert the identification mark into a sync signal.

More specifically, the DVD player 100 may insert the identification mark to the header area of the stream of the left-eye image or the header area of the stream of the right-eye image, if the HDMI standard is applied. For example, the stream structure of one frame of the HDMI is illustrated in FIG. 6 and will be explained in detail below. The DVD player 100 may insert the identification mark into a control period or a data island period of the stream area of the HDMI format. At this time, the DVD player 100 may insert the identification mark into the control period or the data island period in the form of a tag.

Also, the DVD player 100 may insert the identification mark into the sync signal. For example, a vertical sync signal includes an active period (Vactive) and a blanking period (Vblank). The blanking period (Vblank) includes periods Vfront, Vsync, and Vback. A detailed structure of the sync signal will be explained below with reference to FIG. 8. The DVD player 100 may insert the identification mark into the sync signal by changing the polarity of the Vsync. The Vsync of which the polarity has been changed is illustrated in FIG. 7 and will be explained in detail below. Accordingly, the DVD player 100 may make the left-eye image and the right-eye image distinguished by changing the polarity of the Vsync of the right-eye image but not changing the polarity of the Vsync of the left-eye image. Conversely, the DVD player 100 may make the left-eye image and the right-eye image distinguished by changing the polarity of the Vsync of the left-eye image but not changing the polarity of the Vsync of the right-eye image.

After that, the DVD player 100 transmits the identification mark-inserted 3D image data to the 3D TV 200 (S420). More specifically, the DVD player 100 may transmit the identification mark-inserted 3D image data to the 3D TV 200 through an HDMI.

Through the above-described process, the DVD player 100 inserts the identification mark into the 3D image data and transmits the 3D image to the outside.

The 3D TV 200 receives the 3D image data including the identification mark for distinguishing the left-eye image and the right-eye image (S430). More specifically, the 3D TV 200 may receive the identification mark-inserted 3D image data from the DVD player 100 through the HDMI.

After operation S430, the 3D TV 200 distinguishes the left-eye image data and the right-eye image data using the identification mark included in the input 3D image data (S440). Since the 3D TV 200 can clearly distinguish the left-eye image data and the right-eye image data using the identification mark, the 3D TV 200 can output the left-eye image frame at the time that the left-eye image should be output and output the right-eye image frame at the time that the right-eye image should be output.

More specifically, the 3D TV 200 may distinguish the left-eye image and the right-eye image of the 3D image data based on the identification mark which is inserted into the header area of the left-eye image or the header area of the right-eye image, or may distinguish the left-eye image and the right-eye image of the 3D image data based on the identification mark which is inserted in to the sync signal.

More specifically, the 3D TV 200 may distinguish the left-eye image and the right-eye image of the 3D image data based on the identification mark inserted into the header area of the left-eye image or the header area of the right-eye image, if the HDMI standard is applied. For example, a stream structure of one frame according to an HDMI format is illustrated in FIG. 6 and will be explained in detail below. The 3D TV 200 may distinguish the left-eye image and the right-eye image based on the identification mark inserted into the control period or the data island period of the stream area of the HDMI format. That is, the 3D TV 200 reads out the identification mark inserted into the control period or the data island period in the form of a tag, and identifies whether current data is about the left-eye image or the right-eye image.

Also, the 3D TV 200 may distinguish the left-eye image and the right-eye image of the 3D image data based on the identification mark which is inserted into the sync signal. For example, a vertical sync signal includes an active period (Vactive) and a blanking period (Vblank). The blanking period (Vblank) includes periods Vfront, Vsync, and Vback. A detailed structure of the sync signal will be explained in detail with reference to FIG. 8. Herein, the 3D TV 200 perceives the identification mark inserted into the sync signal by detecting whether the polarity of the Vsync has been changed or not and distinguishes the left-eye image and the right-eye image based on the identification mark. The Vsync of which the polarity has been changed is illustrated in FIG. 7 and will be explained in detail below. Accordingly, the 3D TV 200 perceives the left-eye image data if the polarity of the Vysnc has not been changed and perceives the right-eye image data if the polarity of the Vsync has been changed, thereby distinguishing the left-eye image and the right-eye image. Conversely, the 3D TV 200 may perceive the right-eye image data if the polarity of the Vsync has not been changed and perceive the left-eye image data if the polarity of the Vysnc has been changed, thereby distinguishing the left-eye image and the right-eye image.

Also, the 3D TV 200 generates a left-eye image frame and a right-eye image frame which is interpolated to the size of one frame using the input 3D image data (S450). That is, the 3D realization unit 236 generates the left-eye image frame and the right-eye image frame to be displayed on the screen for the sake of realizing a 3D stereoscopic image.

In the case of 3D image data of a field sequential scheme, one field data includes image data corresponding to a half size of one frame. In this case, the 3D TV 200 enlarges or interpolates the distinguished left-eye image field and right-eye image field two times, thereby generating a left-eye image frame and a right-eye image frame to be displayed on the screen of one frame size. However, in the case of 3D image data of a frame sequential scheme, this operation is not required.

The 3D TV 200 displays the left-eye image frame and the right-eye image frame alternately, thereby realizing a 3D image (S460).

Through the above-described process, the 3D TV 200 distinguishes the left-eye image and the right-eye image using the identification mark included in the 3D image data, and displays the left-eye image and the right-eye image alternately, thereby displaying a 3D image.

Hereinafter, the frame sequential scheme and the field sequential scheme, which indicate the type of 3D image data, will be explained. FIG. 5A illustrates 3D image data of the frame sequential scheme according to an exemplary embodiment.

As shown in FIG. 5A, according to the frame sequential scheme, left-eye image data corresponding to one frame and right-eye image data corresponding to one frame are transmitted in sequence. If the left-eye image data and the right-eye image data are transmitted in the frame sequential scheme, the frequency of the left-eye image data and the right-eye image data is two times of the frequency (Vfreq) of a TV screen. This is because the left-eye image and the right-eye image configure one scene of the TV screen.

If the 3D image data is configured in the frame sequential scheme as described above, the 3D TV 200 displays the left-eye image and the right-eye image included in the 3D image data without performing extra enlargement or interpolation, thereby producing a 3D image. Accordingly, if the 3D image data is configured in the frame sequential scheme, the 3D TV 200 can provide a high quality 3D image.

FIG. 5B illustrates 3D image data of a field sequential scheme according to an exemplary embodiment. As shown in FIG. 5B, according to the field sequential scheme, left-eye image data corresponding to one field and right-eye image data corresponding to one field are transmitted in sequence.

Herein, the field refers to image data of a half size of one frame. Accordingly, in the case of 3D image data of the field sequential scheme, one field data includes image data corresponding to a half size of one frame. In this case, the 3D TV 200 enlarges or interpolates the left-eye image field and the right-eye image field two times, thereby generating a left-eye image frame and a right-eye image frame to be displayed on the screen of one frame size.

Also, if the left-eye image data and the right-eye image data are transmitted in the field sequential scheme, the frequency of the left-eye image data and the right-eye image data is two times of the frequency (Vfreq) of a TV screen. This is because the left-eye image and the right-eye image configure one scene of the TV screen.

If the 3D image data is configured in the field sequential scheme as described above, the 3D TV 200 performs enlargement or interpolation additionally and displays the left-eye image and the right-eye image included in the 3D image data, thereby realizing a 3D image. Accordingly, if the 3D image data is configured in the field sequential scheme, the 3D image can be realized even through communications of lower bandwidth.

As described above, according to the frame sequential scheme or the field sequential scheme, a frame or a field corresponding to the left-eye image and the right-eye image is transmitted one by one in sequence. Therefore, in the frame sequential scheme and the field sequential scheme, it is not clear which field or frame indicates a left-eye image or a right-eye image. Accordingly, there is a need for a method for distinguish them. By inserting an identification mark into the left-eye image or the right-eye image the 3D image data as described above, the 3D TV 200 clearly distinguishes the left-eye image and the right-eye image in the frame sequential scheme and the field sequential scheme.

FIG. 6 is a view illustrating a structure of a stream area of an HDMI format according to an exemplary embodiment. As shown in FIG. 6, the stream area of the HDMI format, that is, a transition minimized differential signaling (TMDS) period consists of a control period, a data island period, and a video data period. The control period and the data island period are a period into which header information is input, and the video data period is a period to which actual image data is input.

Accordingly, the identification mark may be inserted into the control period or the data island period of the stream area of the HDMI format in the form of a tag.

Hereinafter, the identification mark which is inserted into a sync signal will be described with reference to FIGS. 7 and 8. FIG. 7 is a view illustrating the identification mark which is inserted using the polarity of the Vsync within the Vblanking, and FIG. 8 is a view illustrating Vactive and Vblank information according to an exemplary embodiment of the present invention.

It can be seen from FIG. 7 that the polarity 710 of the Vsync of the left-eye image shows only a low (−) level and the polarity 720 of the Vsync of the right-eye image shows a low (−) level and a high (+) level alternately one time. The identification mark may be inserted into the Vsync in this way.

FIG. 8 illustrates Vactive and Vblank information of an image of a resolution of 1080P. As shown in FIG. 8, the Vactive period consists of 2205 line periods in total and the Vblank period consists of 45 line periods in total. The Vsync consists of 5 of 45 line periods. Accordingly, regarding the left-eye image, all of the 5 line periods are maintained at a low (−) level, whereas regarding the right-eye image, three line periods are maintained at a high (+) level and two line periods are maintained at a low (−) level, such that the identification mark for distinguishing the left-eye image and the right-eye image can be realized using the Vsync.

As described above, the identification mark may be inserted into the header area of the left-eye image or the header area of the right-eye image, or may be inserted into the sync signal.

Although the 3D image providing apparatus is a DVD player in this exemplary embodiment, this is merely an example. Any apparatus can be applied if it can provide a 3D image. For example, the 3D image providing apparatus may be a video player, a personal video recorder (PVR), and a blue-ray disk (BD) player.

Although the 3D image display apparatus is a 3D TV in this embodiment, this is merely an example. Any apparatus can be applied if it can display a 3D image. For example, the 3D image display apparatus may be a 3D monitor and a 3D image projector.

According to various exemplary embodiments described above, since the identification mark is inserted into the 3D image data including the left-eye image and the right-eye image, for distinguishing the left-eye image and the right-eye image, and the identification mark-inserted 3D image data is transmitted to an external apparatus, the 3D display apparatus can distinguish the left-eye image and the right-eye image of the input 3D image.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

1. A method for providing a 3D image, the method comprising:
inserting an identification mark into 3D image data, the 3D image comprising a left-eye image and a right-eye image, for distinguishing the left-eye image and the right-eye image; and
transmitting the identification mark-inserted 3D image data to a display apparatus.

2. The method as claimed in claim 1, wherein the 3D image data is 3D image data of a frame sequential scheme, wherein a frame corresponding to the left-eye image and a frame corresponding to the right-eye image are transmitted in sequence.

3. The method as claimed in claim 1, wherein the 3D image data is 3D image data of a field sequential scheme, wherein a field corresponding to the left-eye image and a field corresponding to the right-eye image are transmitted in sequence.

4. The method as claimed in claim 1, wherein the inserting inserts the identification mark into one of a header area of the left-eye image or a header area of the right-eye image.

5. The method as claimed in claim 4, wherein the transmitting transmits the identification mark-inserted 3D image data to the display apparatus through a high-definition multimedia interface (HDMI),
wherein the inserting inserts the identification mark into one of a control period or a data island period of a stream area of an HDMI format.

6. The method as claimed in claim 1, wherein the inserting inserts the identification mark into a sync signal.

7. The method as claimed in claim 6, wherein the inserting inserts the identification mark into the sync signal by changing a polarity of a Vsync within a Vblanking period of the sync signal.

8. A 3D image providing apparatus comprising:
a controller which controls an identification mark to be inserted into 3D image data, the 3D image data comprising a left-eye image and a right-eye image, for distinguishing the left-eye image and the right-eye image; and
an interface which transmits the identification mark-inserted 3D image data to a display apparatus.

9. The 3D image providing apparatus as claimed in claim 8, wherein the 3D image data is 3D image data of a frame sequential scheme wherein a frame corresponding to the left-eye image and a frame corresponding to the right-eye image are transmitted in sequence.

10. The 3D image providing apparatus as claimed in claim 8, wherein the 3D image data is 3D image data of a field sequential scheme wherein a field corresponding to the left-eye image and a field corresponding to the right-eye image are transmitted in sequence.

11. The 3D image providing apparatus as claimed in claim 8, wherein the controller inserts the identification mark into one of a header area of the left-eye image or a header area of the right-eye image.

12. The 3D image providing apparatus as claimed in claim 11, wherein the interface transmits the identification mark-inserted 3D image data to the display apparatus through an HDMI,
wherein the controller inserts the identification mark into one of a control period or a data island period of a stream area of an HDMI format.

13. The 3D image providing apparatus as claimed in claim 8, wherein the controller inserts the identification mark into a sync signal.

14. The 3D image providing apparatus as claimed in claim 13, wherein the controller inserts the identification mark into the sync signal by changing a polarity of a Vsync within a Vblanking period of the sync signal.

15. A method for displaying a 3D image, the method comprising:
receiving 3D image data comprising an identification mark for distinguishing a left-eye image and a right-eye image;
distinguishing the left-eye image and the right-eye image of the received 3D image data based on the identification mark;
generating a left-eye image frame corresponding to the left-eye image of the 3D image data and a right-eye image frame corresponding to the right-eye image of the 3D image data, and producing a 3D image; and
displaying the left-eye image frame and the right-eye image frame alternately.

16. The method as claimed in claim 15, wherein the 3D image data further comprises 3D image data of a frame sequential scheme wherein a frame corresponding to the left-eye image and a frame corresponding to the right-eye image are transmitted in sequence.

17. The method as claimed in claim 15, wherein the 3D image data is 3D image data of a field sequential scheme wherein a field corresponding to the left-eye image and a field corresponding to the right-eye image are transmitted in sequence.

18. The method as claimed in claim 15, wherein the distinguishing distinguishes the left-eye image and the right-eye image of the received 3D image data based on the identification mark which is inserted into one of a header area of the left-eye image or a header area of the right-eye image.

19. The method as claimed in claim 18, wherein the receiving receives the identification mark-inserted 3D image data through an HDMI,
wherein the distinguishing distinguishes the left-eye image and the right-eye image of the received 3D image data based on the identification mark which is inserted into one of a control period or a data island period of a stream area of an HDMI format.

20. The method as claimed in claim 15, wherein the distinguishing distinguishes the left-eye image and the right-eye image of the received 3D image data based on the identification mark which is inserted into a sync signal.

21. The method as claimed in claim 20, wherein the distinguishing distinguishes the left-eye image and the right-eye image of the received 3D image data based on the identification mark which corresponds to a polarity of a Vsync within a Vblanking period of the sync signal.

22. A 3D image display apparatus comprising:
an image receiver which receives 3D image data, the 3D image data comprising an identification mark for distinguishing a left-eye image and a right-eye image;
a controller which distinguishes the left-eye image and the right-eye image of the received 3D image data based on the identification mark; and
a 3D realization unit which generates a left-eye image frame corresponding to the left-eye image of the 3D image data and a right-eye image frame corresponding to the right-eye image of the 3D image data.

23. The 3D image display apparatus as claimed in claim 22, wherein the 3D image data is 3D image data of a frame sequential scheme wherein a frame corresponding to the left-eye image and a frame corresponding to the right-eye image are transmitted in sequence.

24. The 3D image display apparatus as claimed in claim 22, wherein the 3D image data is 3D image data of a field sequential scheme wherein a field corresponding to the left-eye image and a field corresponding to the right-eye image are transmitted in sequence.

25. The 3D image display apparatus as claimed in claim 22, wherein the controller distinguishes the left-eye image and the right-eye image of the received 3D image data based on the identification mark which is inserted into one of a header area of the left-eye image or a header area of the right-eye image.

26. The 3D image display apparatus as claimed in claim 25, wherein the image receiver receives the identification mark-inserted 3D image data through an HDMI,
wherein the controller distinguishes the left-eye image and the right-eye image of the received 3D image data based on the identification mark which is inserted into one of a control period or a data island period of a stream area of an HDMI format.

27. The 3D image display apparatus as claimed in claim 22, wherein the controller distinguishes the left-eye image and the right eye image of the 3D image data based on the identification mark which is inserted into a sync signal.

28. The 3D image display apparatus as claimed in claim 27, wherein the controller distinguishes the left-eye image and the right-eye image of the received 3D image data based on the identification mark which corresponds to a polarity of a Vsync within a Vblanking period of the sync signal.

29. The 3D image display apparatus as claimed in claim 22, further comprising a display unit which displays the left-eye image frame and the right-eye image frame alternately.

29. (canceled)

30. A 3D image display apparatus, comprising:
a receiver which receives 3D image data; and
a 3D realization unit which generates right eye image data and left eye image data from the 3D image data;
wherein the right eye image data and left eye image data are distinguished by an identification mark inserted into one of the right eye or left eye image data.

31. A 3D image display system, comprising:
a 3D image generation apparatus which reads out a right eye image data and a left eye image data, and inserts an identification mark into one of the right or left eye image data;
a 3D image display apparatus which receives the right eye image data and left eye image data from the 3D image generation apparatus and generates the right eye image and left eye image from the right and left eye image data;
wherein the right eye image data and left eye image data are distinguished by the insertion of the identification mark into one of the right eye or left eye image data; and
a set of glasses which are synchronized with the right eye image and left eye image.

32. A 3D image generation apparatus, comprising:
a player function block which reads out a right eye image data and a left eye image data; and
a controller which inserts an identification mark into one of the right eye image data or the left eye image data.
